(19) United States
(12) Patent Application Publication
(10) Pub. No.: US 2011/0056921 A1
(43) Pub. Date: Mar. 10, 2011

(54) MACHINING HEAD FOR A LASER MACHINING MACHINE COMPRISING A GAS SUPPLY AND A COMPENSATION UNIT FOR COMPENSATING THE FORCES TRANSMITTED BY THE SUPPLIED GAS

(75) Inventor: Marco Belletti, Walliswil Bei Wangen (CH)

(73) Assignee: Bystronic Laser AG, Niederoenz (CH)

(21) Appl. No.: 12/734,801

(22) PCT Filed: Nov. 25, 2008
(86) PCT No.: PCT/CH2008/000497

§ 371 Date: Oct. 12, 2010

(30) Foreign Application Priority Data
Nov. 26, 2007 (EP) 07405335.6

(51) Int. Cl. B23K 26/14

(52) U.S. Cl. 219/121.67

(57) ABSTRACT

The invention relates to a machining head (10) for a laser machining machine (1) for machining a workpiece (2) by means of a laser beam (5), comprising focusing optics (25) that focus the laser beam; and comprising a drive device (40) for moving and/or adjusting the focusing optics (25), which drive device is designed as a fluidic drive (40); wherein a gaseous stream can be introduced to an area (75) bordering the focusing optics (25) on the incident end of the laser beam (5), and the respective outlet opening (63; 73) is arranged at a predetermined distance from the focusing optics (25) so that the spatial arrangement of the outlet opening relative to the focusing optics cannot be changed if the focusing optics are moved or displaced.

The invention relates to a machining head for a laser machining machine for machining a workpiece by means of a laser beam.

A machining head of a laser machining machine is the last element of a beam guidance device of a laser beam that is used for machining a workpiece by means of the laser machining machine. As a rule, it is the task of a machining head to focus the laser beam on the workpiece to be machined, and if applicable, in addition, to guide a process gas or several different process gases into the surroundings of the focal point of the respective laser beam in order to influence the machining processes (for example cutting a workpiece, welding several workpieces together, producing engraving on surfaces, or similar) that are induced by the laser beam, by means of the respective process gas. Therefore, a machining head as a rule comprises at least one set of focusing optics and one adjustment mechanism that is used to move or adjust the focusing optics in order to be able to change the distance of the focusing optics relative to the workpiece to be machined, and thus to be able to influence the position of the focal point relative to the workpiece. Furthermore, as a rule, a machining head comprises a number of sensors for acquiring various operating parameters (for example for controlling the position of the machining head, for monitoring the quality of the respective result of machining with the laser beam, for monitoring the integrity of the focusing optics, or similar), electronics for processing the respective sensor signals and for communicating with a control device of the laser machining machine, and a supply of various media (for example energy and/or coolants and/or process gases for influencing machining processes, and/or gases for cleaning and cooling the focusing optics).

With regard to the supply of gases, in the construction of a machining head it must be taken into account that these gases in the operation of a laser machining machine are supplied at overpressure, in some cases at high pressure, and are, as a rule, introduced to an area that is directly adjacent to the focusing optics. The supplied gases can therefore transmit forces to the focusing optics. Process gases that for the purpose of influencing machining processes are guided from a machining head to a workpiece to be machined are, for example, supplied at a pressure ranging from 0.1 to approx. 30 bar and can therefore transmit forces to the focusing optics, which forces can, on the one hand, reach high values, and on the other hand (depending on the application) can also vary over a large range. Since, during machining of a workpiece, in each case the position of the focusing optics needs to be precisely controlled, and if applicable the position of the focusing optics needs to be changed in a targeted manner, it is thus necessary when adjusting the focusing optics to take into account the forces transmitted by the supplied gases.

Several concepts are already known on this subject matter.

From DE 41 29 278 A1, for example, a machining head of a laser machining machine is known whose focusing optics can be pneumatically adjusted. The focusing optics are attached to a movably-held lens holding arrangement which in each case on opposite ends, i.e. on the outlet end of the laser beam and on the incident end of the laser beam, comprises a piston surface. In each case both piston surfaces are guided in a gas chamber that can be flooded with a gas. In the present example one of the gas chambers is flooded with the process gas required for machining the respective workpiece, namely at the operating pressure that has to be implemented during the respective machining process. The other gas chamber is filled with a control gas (for example compressed air or process gas), wherein the pressure of the control gas in the other chamber—depending on the (operating) pressure of the process gas in the one gas chamber—has to be regulated in order to be able to automatically adjust the focusing optics in a targeted manner. This adjustment mechanism for adjusting the focusing optics is associated with various disadvantages. For example, the control gas must also be highly pressurised in order to be able to achieve precise adjustment of the focusing optics in the face of the at times high pressure of the process gas. Precise control of the pressure of the control gas in the respective gas chamber therefore requires complicated regulation. Furthermore, adjustment of the focusing optics is impossible or is possible only with difficulty when no process gas is required or when the process gas is impinged on only by pressure that is too low to move the focusing optics against its weight.

From DE 196 28 857 A1 a machining head of a laser machining machine is known whose focusing optics are adjustable by means of a drive device. The proposed drive device is a manual, electromechanical or pneumatic drive device, wherein in relation to a pneumatic drive device there is, however, no concrete proposition as to how such a drive device could be implemented. A pressure compartment is provided as a supply of a process gas, which pressure compartment is arranged on the focusing optics on the outlet end of the laser beam, wherein a pressurised process gas can be introduced to said pressure compartment. In order to largely suppress the influence of forces that are transmitted to the focusing optics by the process gas, a compensation unit is provided that is to ensure that these forces that are due to the process gas are to be compensated for. For this purpose a movable carrier unit, which carries the focusing optics, on the incident end of the laser beam comprises a piston surface that projects into a gas chamber. A gas can be introduced to this gas chamber, wherein the pressure of this gas is selected in such a manner that the carrier unit of the focusing optics is kept balanced. In principle it is possible to supply the pressure compartment and the gas chamber with pressurised gas by way of separate lines. However, this solution is associated with a disadvantage in that a complicated control device is required to attune the pressure in the gas chamber to the pressure, at that particular time, of the process gas in the pressure chamber, and to keep the focusing optics balanced. According to an alternative exemplary embodiment of the compensation unit the pressure compartment and the pressure chamber communicate with each other by way of at least one connecting channel that is situated in the interior of the machining head. In this way it is possible to achieve simple pressure equalisation between the pressure compartment and the gas chamber. However, this solution is also associated with significant disadvantages. For example, the gas chamber and the connecting channel between the gas chamber and the pressure compartment form a “dead” space in which the respective process gas that has been introduced can be stored for an extended period of time. This is disadvantageous if during operation of the laser machining machine a change in the process gas becomes necessary, i.e. in the case of replacement of a first process gas used in a first machining step by a second (different) process gas in a second (subsequent) machining step. In such a change in the process gas a residue of the first process gas that is present in the gas chamber and/or in the connecting channel can contaminate the second process gas for an extended period of time and can thus have a negative impact on the implementation of the second process step, all the more so since even minor contamination of a process gas can already lead to unacceptable results. However, in the present case any special cleaning of the gas chamber and of the connecting channel in order to remove any previously introduced process gas prior to a change in the process gas would be expensive and time-consuming. For this reason a lot of time is lost during a change in process gas before normal operation of the laser machining machine (without any negative effect resulting from contaminated process gases) becomes possible. There is a further disadvantage in that the compensation unit takes up a lot of space, all the more so since the pressure compartment and the gas chamber require space near the focusing optics both on the incident end of the laser beam and on the outlet end of the laser beam, and since, in addition, space for the connecting channel is required. In addition this makes it difficult to integrate a supply for further gases, e.g. for a gas that is to be introduced to an area on the incident end of the laser beam.

It is the object of the present invention to avoid the above-mentioned disadvantages and to propose a machining head of a laser machining machine with a compensation unit for compensating for the forces transmitted by the supplied gas, whose compensation unit requires little space while making it possible to achieve a quick gas change.

According to the invention this object is met by a machining head with the characteristics of claim 1.

The machining head according to the invention comprises:
focusing optics that focus the laser beam;
a drive device for moving and/or adjusting the focusing optics, which drive device is designed as a fluidic drive;
at least one supply for at least one pressurised gas, which supply comprises at least one outlet opening for the respective gas, wherein gas can be channelled to the respective outlet opening, and from the supply can be introduced, through the respective outlet opening, as a gaseous stream into an area bordering the focusing optics;
at least one compensation unit to compensate for forces that can be transmitted to the focusing optics by the respective gaseous stream.

The compensation unit comprises a gas chamber that can be flooded with the respective gas, and a piston surface that can be moved in the gas chamber and that can be impinged on by the respective gas and that is rigidly connected to the focusing optics, wherein the piston surface is arranged in such a manner that forces that can be transmitted to the focusing optics by means of the respective gaseous stream are entirely or partly compensated for by forces that can be transmitted to the piston surface by means of the respective gas.

In this arrangement the gas flow is integrated in the supply in such a manner that the gas chamber can be flooded with gas that is channelled to the respective outlet opening through at least one inlet opening in the gas chamber, wherein after passing through the respective inlet opening the gas must flow through the gas chamber in order to reach the respective outlet opening. Furthermore, the gas chamber is designed so as to be concentric to the direction of propagation of the laser beam, and the piston surface that can be impinged on by the gas comprises the shape of a ring that is concentric relative to the direction of propagation of the laser beam.

As a result of the gas chamber forming part of the supply and as a result of a gas being forced through said gas chamber, the gas chamber cannot constitute a “dead” space (in contrast to the proposal for a compensation unit set out in DE 196 28 857 A1), in which “dead” space, after the supply of a first gas to the supply, residues of this first gas are stored for an extended period of time, when the supply of this first gas ceases and when (during a gas change) instead of the first gas a second (other) gas is introduced to the supply. During a gas change the gas chamber can quickly be “rinsed” (cleaned) by the second gas, and can thus be purged of residues of the first gas. A gas change can therefore be carried out relatively quickly.

Integration of the gas chamber in the supply makes it possible to arrange the gas chamber in close proximity to the outlet opening, from which outlet opening gas from the respective supply can be introduced as a gaseous stream into an area bordering the focusing optics. The respective compensation unit therefore requires little space. Accordingly, it is possible without further ado to design the machining head with several supplies for gas, and to provide a compensation unit for each individual supply, which compensation unit is integrated according to the invention into the respective supply.

The respective gas chamber is designed so as to be concentric to the direction of propagation of the laser beam, and the piston surface that can be impinged on by the gas comprises the shape of a ring that is concentric relative to the direction of propagation of the laser beam. In this case the gas chamber can be arranged in an annular shape around the focusing optics. This compensation unit can be designed so as to be particularly compact. Furthermore, as a result of this arrangement the forces transmitted to the respective piston surface can be evenly distributed over the circumference of the focusing optics. In this way it is possible to prevent one-sided loading of the focusing optics as a result of the disturbance forces transmitted by the gas, and the respective disturbance forces can be eliminated in an efficient manner.

Since the compensation unit ensures that there is compensation for the forces transmitted by the supplied gas, the drive unit merely needs to be able to move, and if applicable to hold, the mass of the focusing optics. To this effect the drive unit is designed as a fluidic drive. This is particularly advantageous because this drive unit usually also comprises piston surfaces that are impinged on by a pressurised fluid, and can therefore be implemented using similar technical means as is the case with the compensation unit. A fluidic drive makes it possible, in particular, to achieve a compact design and fast and precise adjustment of the focusing optics.

According to the invention, the respective outlet opening of the supply is arranged in such a manner that the respective gaseous stream can be introduced to an area bordering the focusing optics on the incident end of the laser beam. Consequently, the gas chamber of the compensation unit can preferably be arranged in close proximity to the incident end of the laser beam on the focusing optics. This is a particularly space-saving arrangement. This embodiment is, for example, suitable for feeding a gas for cleaning and/or cooling the focusing optics on the incident end of the laser beam.

One embodiment of the machining head according to the invention comprises, for example, a supply for gas, comprising at least one outlet opening that is arranged in such a manner that the respective gaseous stream is introduced to an area bordering the focusing optics on the outlet end of the laser beam. In this case the gas chamber of the compensation unit can preferably be arranged in close proximity to the outlet end of the laser beam on the focusing optics. This is a particularly space-saving arrangement. This embodiment is evidently particularly suitable for feeding to the laser machining machine process gas for influencing a machining process induced by a laser beam.

Another embodiment of the machining head according to the invention comprises the combination of the characteristics of the two above-mentioned embodiments, i.e. a supply for a first gas to an area bordering the focusing optics on the outlet end of the laser beam, in combination with a compensation unit according to the invention, to compensate for the forces transmitted by this first gas, and at least one further supply for a second gas to an area bordering the focusing optics on the incident end of the laser beam, in combination with a compensation unit according to the invention for compensating for the forces transmitted by this second gas.

The respective outlet opening of the respective supply for a gas can be arranged at a predetermined distance from the focusing optics so that the spatial arrangement of the outlet opening relative to the focusing optics cannot be changed if the focusing optics are moved or displaced. This variant provides an advantage in that the respective gaseous stream flowing through the outlet opening always follows the same path relative to the focusing optics, even if the focusing optics are moved or displaced by means of the drive device. This provides several advantages. Firstly, interfering interactions between the respective gaseous stream and the operation of the drive device are avoided. Furthermore, the influence the gaseous stream has on the focusing optics is independent of the position, at that particular time, of the focusing optics. This applies, for example, to the cooling effect or to the cleaning effect which the gas has on the focusing optics.

The machining head according to the invention can be of a modular design, i.e. the machining head can comprise a stationary part and an interchangeable replacement module. In this document the term “stationary part” of the machining head refers to any components of the machining head with the exception of the replacement module, i.e. all the components of the machining head, from which components the respective replacement module (during removal of the respective replacement module from the “stationary part”) can be separated as a whole, without it being necessary to dismantle the “stationary part” into individual components. In one variant, the replacement module can comprise the focusing optics and the respective compensation unit. According to an improvement of this variant, the replacement module additionally comprises the respective driven parts of the drive device, wherein it is assumed that the drive device comprises at least one driven part. This modular design simplifies service and maintenance, as well as simplifying the exchange of the focusing optics, of the drive device, and of the compensation unit.

Further details of the invention, and in particular exemplary embodiments of the invention, are explained below with reference to the enclosed drawings. The following are shown:

FIG. 1 a laser machining machine for machining a workpiece by means of a laser beam, with a modular machining head, wherein a replacement module comprising focusing optics has been moved to a stationary operating position relative to the stationary part of the machining head;

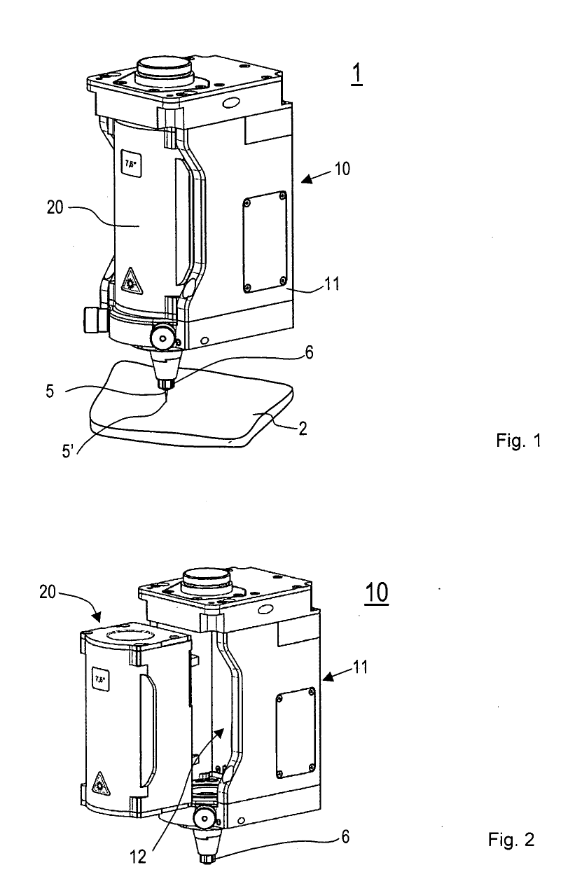

FIG. 2 the machining head according to FIG. 1, wherein the replacement module is removed from the stationary operating position and is separate from the stationary part of the machining head;

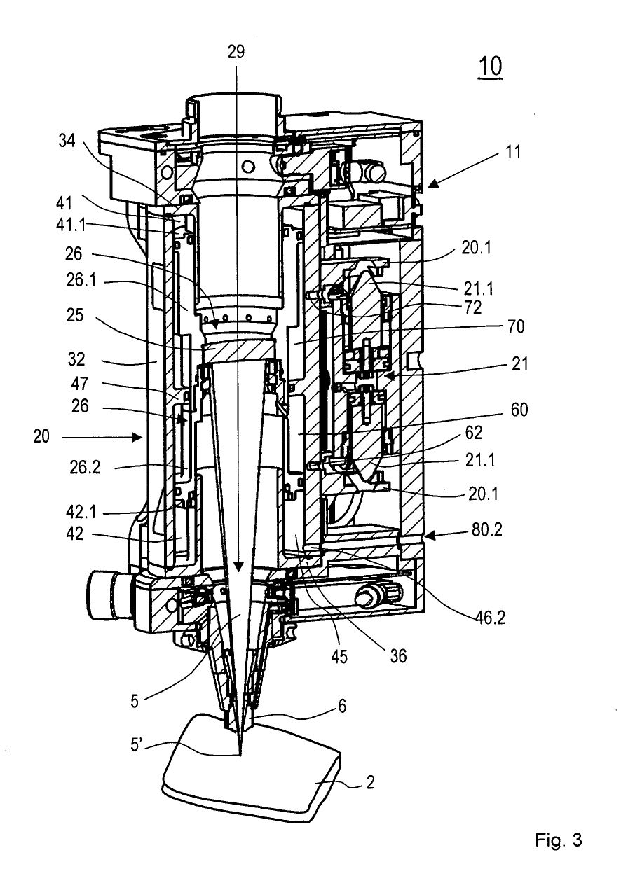

FIG. 3 the machining head according to FIG. 1, in a 3D-view, wherein the machining head is shown in a section view along the direction of propagation of the laser beam;

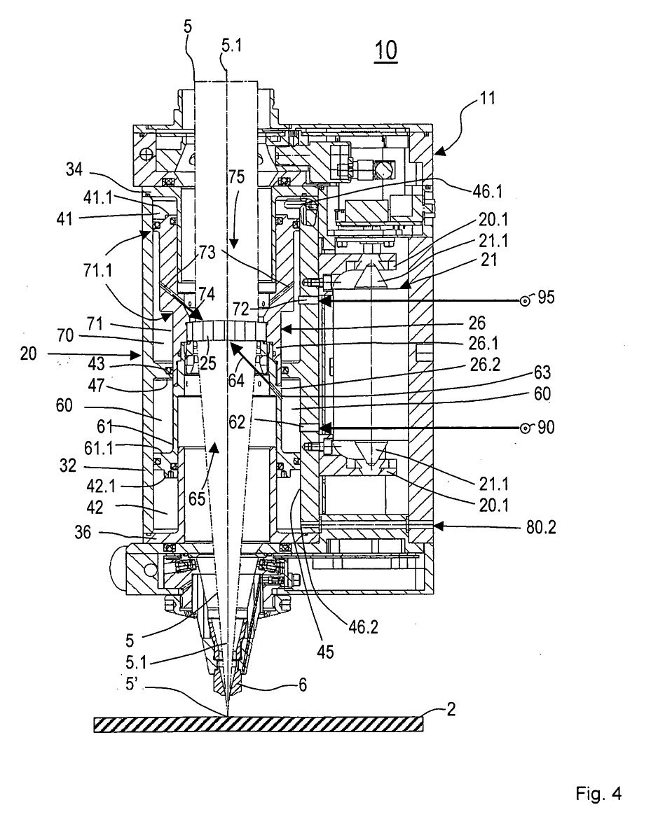

FIG. 4 the machining head according to FIG. 1, in a section along the direction of propagation of the laser beam;

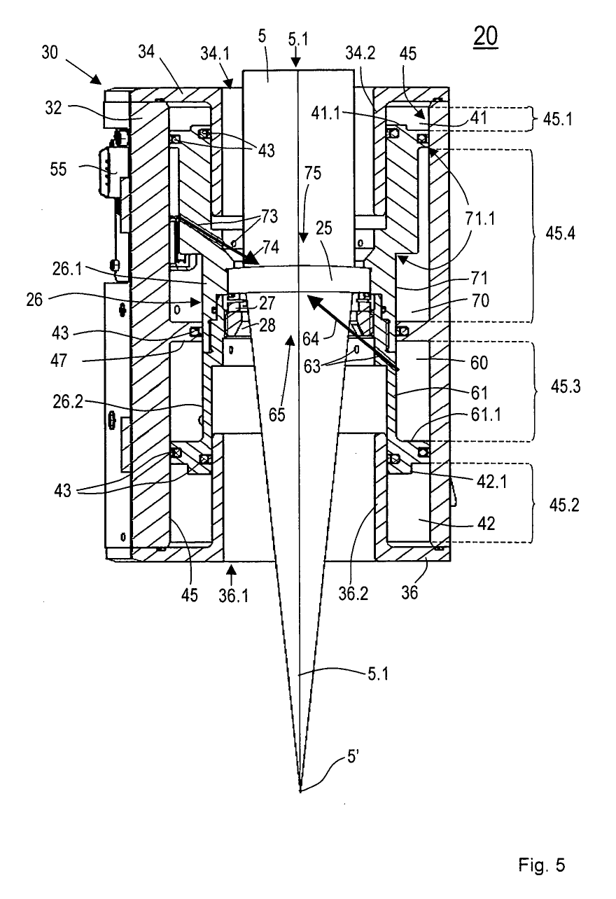

FIG. 5 a replacement module for the machining head according to FIG. 1, wherein the replacement module is shown in a section along the direction of propagation of the laser beam;

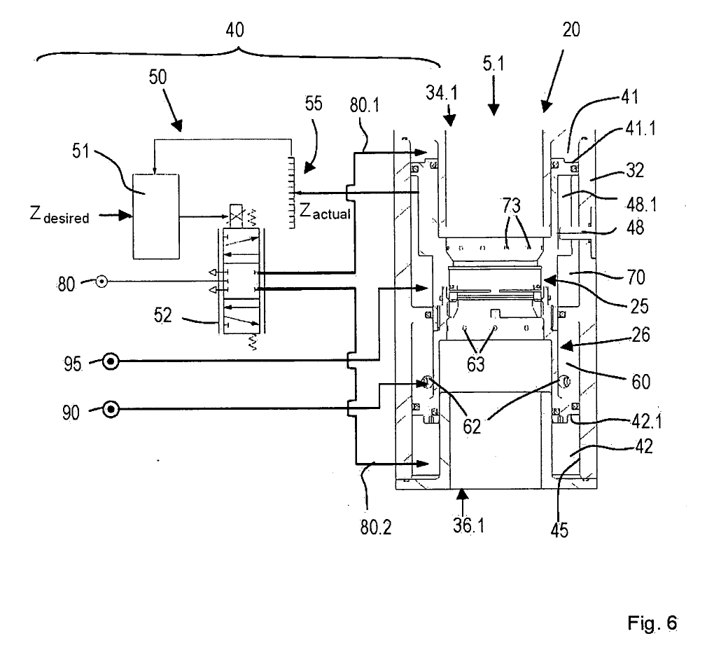

FIG. 6 the replacement module according to FIG. 4, in a section along the direction of propagation of the laser beam, together with a fluidic drive for moving focusing optics.

FIG. 1 shows a laser machining machine 1 comprising a machining head 10 according to the invention. In the present example the laser machining machine 1 is shown in operation while in the process of machining a workpiece 2 by means of a laser beam 5, wherein the laser beam 5 exits from an outlet opening (shown in FIGS. 2 and 3) of a nozzle 6. In the present case the laser beam 5 is focused, by means of focusing optics that will be explained in the context of FIGS. 3-5, on a surface of the workpiece 2 (a surface of the workpiece 2 is in focus 5′ of the focusing optics). The nozzle 6 furthermore makes it possible to guide a stream of a process gas in the surroundings of the laser beam 5 to the workpiece 2 in order to be able to influence machining of the workpiece 2 by means of the process gas. FIG. 1 is a simplified diagram of a laser machining machine 1: the machining head 10 is movable relative to the workpiece 2, for example by means of a robot arm (not shown in FIG. 1).

As shown in FIGS. 1 and 2, the machining head 10 comprises a stationary part 11 in the form of a housing that is open on one side, which housing encloses a space 12 for a replacement module 20. The replacement module 20 can be slid into the space 12 so as to be perpendicular to the direction of propagation 5.1 of the laser beam 5, and can be pulled out correspondingly. In the illustration according to FIG. 1 the replacement module 20 is in a stationary operating position relative to the stationary part 11 of the machining head 10. FIG. 2 shows that the replacement module 20 as a whole can be separated from the stationary part 11 of the machining head 10 without there being any need to dismantle the stationary part into individual components.

FIGS. 3 and 4 show design details of the stationary part 11 of the machining head 10 and of the replacement module 20, wherein the replacement module 20 is shown in a stationary operating position relative to the stationary part 11. FIG. 5 separately shows the replacement module 20, separated from the stationary part 11, wherein further details (not shown in FIGS. 3 and 4) of the replacement module 20 are shown.

In order to move the respective replacement module 20 precisely to the stationary operating position and to be able to hold it in the stationary operating position, the stationary part 11 of the machining head 10 comprises a centring and holding device 21 for the replacement module 20. The holding device 21 comprises two centring pins 21.1, each being conical at one end, which centring pins 21.1 are movable by means of a control device (not shown) in such a manner that in each case their conical ends can engage corresponding centre holes located in the two arms 20.1 attached to an outside of the replacement module 20 (FIG. 3). By moving the centring pins 21.1 into the above-mentioned centre holes in the arms 20.1, the replacement module 20 can be centred, moved to the stationary operating position, and held in the stationary operating position. Correspondingly, the two centring pins 21.1 can be moved from the centre holes in the arms 20.1 in order to release the arms 20.1 and to make it possible for the replacement module 20 to be removed from the space 12.

As shown in FIGS. 3-5, the replacement module 20 comprises focusing optics 25 which in the present embodiment comprise a lens. The focusing optics 25 are arranged in such a manner that the optical axis of the focusing optics 25 coincides with the direction of propagation 5.1 of the laser beam 5 (coaxial arrangement) when the replacement module 20 has been moved to its stationary operating position.

In order to make it possible for the laser beam 5 to be focused on various distances relative to the nozzle 6, the focusing optics 25 are further arranged in such a manner that their focus 5′ can be moved along the direction of propagation 5.1 of the laser beam or of the optical axis of the focusing optics 25 (coaxially) when the replacement module 20 has been moved to its stationary operating position.

To this effect the replacement module 20 comprises a support structure 30 for the focusing optics 25, which support structure 30 makes it possible to move the focusing optics 25 coaxially to the direction of propagation 5.1 when the replacement module (and thus also the support structure 30) has been moved to its stationary operating position.

The support structure 30 has several functions: it is used as a housing for the replacement module 20 and to guide the focusing optics 25 in a movement of the focusing optics 25 along the direction of propagation 5′ of the laser beam 5, and, furthermore, said support structure 30 forms part of a drive device 40 (FIG. 6) for moving the focusing optics 25, which drive device 40 can be fluidically activated.

As shown in FIG. 5 in conjunction with FIGS. 3, 4 and 6, the support structure 30 is designed as a hollow body, comprising:
a sidewall 32 that laterally delimits a cylindrical hollow space, wherein the inside of the sidewall 32 forms a hollow-space wall 45 which comprises a circular cross section relative to the longitudinal direction of the sidewall 32;
a closing plate 34 that is attached to one end of the sidewall 32 and comprises a circular inlet opening 34.1 for the laser beam 5, wherein a tube 34.2 comprising a round cross section is affixed to the closing plate 34, which tube 34.2 is arranged coaxially to the hollow-space wall 45 and surrounds the inlet opening 34.1;
a closing plate 36 that is attached to the other end of the sidewall 32 and comprises a circular outlet opening 36.1 for the laser beam 5, wherein a tube 36.2 comprising a round cross section is affixed to the closing plate 36, which tube 36.2 is arranged coaxially to the hollow-space wall 45 and surrounds the outlet opening 36.1. The closing plate 34 delimits the replacement module 20 on the incident end of the laser beam 5, while the closing plate 36 delimits the replacement module 20 on the outlet end of the laser beam 5.

As indicated in FIGS. 3-5 the tubes 34.2 and 36.2 are arranged in such a manner relative to the hollow-space wall 45 that between the hollow-space wall 45 and each of the tubes 34.2 and 36.2 an annular gap is formed. FIGS. 3-5 further show that the hollow-space wall 45, the inlet opening 34.1, the circular outlet opening 36.1 and the tubes 34.2 and 36.2 are arranged coaxially or concentrically relative to the direction of propagation 5.1 when the replacement module 20 is in the stationary operating position.

The focusing optics 25 are installed in a lens mount 26 that for reasons associated with installation comprises two tubular parts 26.1 and 26.2, and a through-passage 29 for the laser beam 5 (FIG. 3). The focusing optics 25 are arranged in the through-passage 29 and are attached to the lens mount 26 by means of a spring washer 27 and a nut 28 in order to ensure a stable seat of the focusing optics 25.

In order to be able to ensure a precisely controllable movement of the focusing optics 25 relative to the support structure 30 of the replacement module, the lens mount 26 is, furthermore, shaped in such a manner that it can be arranged and guided in the hollow space surrounded by the support structure 30, and can also serve as a piston unit, which can be activated by means of a fluid, of the drive device 40. To this effect the lens mount 26 is designed as follows:
a) As shown in FIGS. 3-6, the lens mount 26 is dimensioned in such a manner that when it is inserted in the replacement module 20 the part 26.1 of the lens mount 26 projects into the annular gap that is formed between the hollow-space wall 45 and the tube 34.2, and that the part 26.2 of the lens mount 26 projects into the annular gap that is formed between the hollow-space wall 45 and the tube 36.2. In this arrangement the end of the lens mount 26 (part 26.1) that faces the closing plate 34 is formed in such a manner that the outside of the lens mount 26 rests in a positive-locking manner against the hollow-space wall 45, while the inside of the lens mount 26 rests in a positive-locking manner against the tube 34.2. Correspondingly, the end of the lens mount 26 (part 26.2), which end faces the closing plate 36, is formed in such a manner that the outside of the lens mount 26 rests in a positive-locking manner against the hollow-space wall 45, while the inside of the lens mount 26 rests in a positive-locking manner against the tube 36.2. Consequently, the lens mount 26 is guided by the hollow-space wall 45 and by the tubes 34.2 and 36.2.
b) The extension of the lens mount 26 in longitudinal direction of the sidewall 32 of the replacement module 20 is selected in such a manner that the lens mount 26 can be moved by a predetermined distance coaxially to the direction of propagation 5.1 of the laser beam along the hollow-space wall 45. In order to prevent rotation of the lens mount 26 a pin 48 can be inserted into the sidewall 32 in such a manner that the pin 48 engages a groove 48.1 which is located on one side of the lens mount 26 so as to be parallel to the optical axis of the focusing optics 25 (FIG. 6).
c) The end of the closing plate 34, which end faces the lens mount 26 (part 26.1), forms an annular surface that is sealed against the hollow-space wall 45 and the tube 34.2 by means of seals 43, and that serves as a first piston surface 41.1 of the drive unit 40. Correspondingly, the end of the lens mount 26 (part 26.2), which end faces the closing plate 36, forms an annular surface which is sealed against the hollow-space wall 45 and the tube 36.2 by means of seals 43, and serves as a second piston surface 42.1 of the drive unit 40. As will be explained in more detail below, the two piston surfaces 41.1 and 42.1 can be impinged on by a pressurised fluid in order to be able to move the lens mount 26 relative to the support structure 30. The piston surfaces 41.1 and 42.1, or the lens mount 26, can therefore be considered to be driven parts of the drive unit 40.

As shown in FIGS. 3-6, the drive unit 40 further comprises a first pressure chamber 41 and a second pressure chamber 42. In the region of a first wall section 45.1 of the hollow-space wall 45 within the annular gap that has formed between the hollow-space wall 45 and the tube 34.2, the first pressure chamber 41 is delimited by the first piston surface 41.1 and the closing plate 34. Correspondingly, in the region of a second wall section 45.2 of the hollow-space wall 45 within the annular gap that has formed between the hollow-space wall 45 and the tube 36.2, the second pressure chamber 42 is delimited by the second piston surface 42.1 and the closing plate 36. The pressure chambers 41 are designed in such a manner that when the lens mount 26 moves along the hollow-space wall 45, the volume of the first pressure chamber 41 and the volume of the second pressure chamber 42 is increased or decreased (depending on the direction of movement).

By way of an inlet opening 46.1 in the sidewall 32 of the support structure 30 the first pressure chamber 41 can be filled with a first fluid. Correspondingly, by way of an inlet opening 46.2 in the sidewall 32 of the support structure 30 the second pressure chamber 42 can be filled with a second fluid.

In the present case, differentials between the respective pressure of the first fluid in the first pressure chamber 41 and the respective pressure of the second fluid in the second pressure chamber 42 ensure displacement of the lens mount 26 along the direction of propagation 5.1 of the laser beam 5. Correspondingly, by regulating the pressure of the respective fluid in the first pressure chamber 41 or in the second pressure chamber 42 the position of the focusing optics 25 relative to the support structure 30 can be controlled and can be changed by predetermined distances along the direction of propagation 5.1 of the laser beam 5.

As indicated in FIGS. 3-6, the drive device 40 (as a supply device for a first fluid) comprises a pressure line 80.1 for a first fluid, which pressure line 80.1 leads to the stationary part 11 of the machining head 10. The inlet opening 46.1 is arranged in the sidewall 32 of the replacement module 20 in such a manner that the pressure line 80.1 automatically communicates with the inlet opening 46.1 or with the first pressure chamber 41 when the replacement module 20 has been moved to the stationary operating position. Correspondingly, the drive device 40 (as a supply device for a second fluid) comprises a pressure line 80.2 for a second fluid, which pressure line 80.2 leads to the stationary part 11 of the machining head 10. The inlet opening 46.2 is arranged in the sidewall 32 of the replacement module 20 in such a manner that the pressure line 80.2 automatically communicates with the inlet opening 46.2 or with the second pressure chamber 42 when the replacement module 20 has been moved to the stationary operating position.

As shown in FIG. 6, in each case a fluid can be introduced to the pressure lines 80.1 and 80.2, which fluid is removed from a pressure line 80 and can be supplied to the pressure lines 80.1 and 80.2 by way of a controllable regulating valve 52. The regulating valve 52 can, for example, be designed as a proportional valve that makes it possible to control the respective pressure in the pressure lines 80.1 or 80.2 and thus in the first pressure chamber 41 or in the second pressure chamber 42 independently of each other depending on control signals. The drive device 40 further comprises a control system 50 that controls positioning of the focusing optics 25, thus controlling the adjustment of the focusing optics according to corresponding inputs from the control device of the laser machining machine 1 (depending on the respective machining process that is to be carried out by the laser machining machine 1). The control system 50 comprises a measuring device 55 for determining the position of the focusing optics 25 and comprises a regulator 51. The measuring device 55 generates signals that represent the position at that particular time (“actual value”) of the focusing optics 25 (in FIG. 6 designated Z_{actual}). It is the task of the regulator 55 to compare the signals of the measuring device 55 with signals that indicate a desired value predetermined by the control device of the laser machining machine 1 in relation to the position of the focusing optics 25 (in FIG. 6 designated Z_{desired}) and in the case of a difference between the desired value and the actual value, by means of suitable signals, act on the regulating valve 52 in such a manner that the focusing optics 25 are moved into the predetermined desired position.

As shown in FIG. 5, the measuring device 55 can be integrated in the replacement module 20. The measuring device 55 can, for example, be designed as a non-contacting measuring system, for example based on a scale (which can, for example, be read using optical or magnetic means), which scale can be arranged on the lens mount 26, and based on a corresponding reading head that can be affixed to the support structure 30 and that is suitable for the scale to be read from it.

The first or second fluid of the drive device 40 can, for example, be a gas or a suitable liquid. As far as a liquid is concerned, in particular a liquid coolant (for example de-ionised water) would be suitable, which is associated with an advantage in that the coolant can ensure effective cooling of the lens mount 26 at high laser outputs.

The replacement module 20 is designed in such a manner that process gases can be channelled from a space bordering the focusing optics 25 on the outlet end of the laser beam 5 through the outlet opening 36.1 of the replacement module 20 and through the nozzle 6 of the machining head 10 and onto the workpiece 2 to be machined.

In order to ensure the supply of process gas, a process gas chamber 60 is integrated in the replacement module 20, which process gas chamber 60 can be flooded with a process gas or a mixture of process gases. As shown in FIG. 5, on a side opposite a third wall section 45.3 of the hollow-space wall 45 the lens mount 26 comprises a first wall region 61, which together with the third wall section 45.3 of the hollow-space wall 45 delimits the process gas chamber 60.

In order to supply process gas, the stationary part 11 of the machining head 10 is connected to a supply device 90 that provides process gas at high pressure (for example 25 bar). In the region of the process gas chamber 60 the sidewall 32 of the replacement module 20 comprises several inlet openings 62 for the process gas. In each case the inlet openings 62 are arranged in such a manner that they are connected to the supply device 90 for the process gas when the support structure 30 has been moved to the stationary operating position.

By way of a multitude of outlet openings 63 for the respective process gas, the process gas chamber 60 is connected to an area 65 bordering the focusing optics 25 on the outlet end of the laser beam 5, into which area 65, by way of each of the outlet openings 63, in each case a gaseous process-stream 64 (in FIGS. 4 and 5 designated by an arrow representing one of the outlet openings 63) can be introduced from the process gas chamber 60.

As shown in FIG. 5, the respective gaseous process-stream 64 on the outlet end of the laser beam 5 is directed onto the focusing optics 25, and from there it is deflected in the direction of the outlet opening 36.1 or the focus 5′. Since the respective gaseous process-stream 64 impinges on the focusing optics 25, the process gas can, for example, be used for cooling the focusing optics 25.

Since the respective gaseous process-stream 64 (depending on the respective machining process) impinges on the focusing optics 25 at high pressure (for example 25 bar), relatively great forces can be transmitted by the process gas, which forces act in the direction of the inlet opening 34.1 essentially coaxially to the direction of propagation 5.1 of the laser beam.

The process gas chamber 60 is designed in such a manner that these forces resulting from the process gas can be compensated for. To this effect the first wall region 61 of the lens mount comprises a piston surface 61.1 that is impinged on by the process gas, which piston surface 61.1 is arranged in such a manner that forces that on the outlet end of the laser beam are transmitted to the focusing optics 26 by means of the respective gaseous process-stream 64 are entirely or partly compensated for by forces that are transmitted to the piston surface 61.1 by means of the process gas. The extent to which the above-mentioned forces are compensated for essentially depends on the size of the piston surface 61.1 when compared to the area of the focusing optics 25 that is impinged on by the process gas. By means of a suitable selection of the size of the piston surface 61.1 a situation can thus be achieved in which all the forces that act on the focusing optics 25 due to forces resulting from the process gas can be precisely compensated for.

In this context the term “supply for the process gas” can refer to the totality of the following components: the supply device 90, the inlet openings 62, the process gas chamber 60, and the outlet openings 63 for the process gas.

The term “compensation unit” to compensate for the forces transmitted by the process gas can refer to the totality of the following components: the process gas chamber and the piston surface 61.1.

The process gas chamber 60 is designed so as to be concentric to the direction of propagation 5.1 of the laser beam 5. Furthermore, the piston surface 61.1 that can be impinged on by the process gas comprises the shape of a ring that is concentric relative to the direction of propagation 5.1 of the laser beam 5. Since the process gas chamber 60 is thus arranged so as to be coaxial to the direction of propagation 5.1 of the laser beam, and also in a ring-shape around the focusing optics 25, as a result of this arrangement the forces transmitted to the piston surface 61.1 can be evenly distributed over the circumference of the focusing optics 25, and thus process-gas-related disturbance forces can be eliminated in an efficient manner.

The arrangement of the process gas chamber 60 provides further advantages with regard to process gas-changes, i.e. replacing a first process gas used in a first machining step with a second (different) process gas in a second (subsequent) machining step. In each case the respective process gas flows through the gas chamber 60 on its way to the outlet openings 63. During a change of process gas from the first process gas to the second process gas, the process gas chamber 60 is “rinsed” by the second process gas, with the effect that after a relatively short period of time there are no longer any residues of the first process gas present. The process gas chamber 60 thus does not form a “dead” space in which residues of the first process gas can be stored for an extended period of time. It is thus possible to prevent any lasting contamination of the second process gas by the first process gas after a change in process gas, or special cleaning (rinsing) of the process gas chamber 66 prior to a change in process gas can be carried out in a short time.

The replacement module 20 is designed in such a manner that the focusing optics 25 on the incident end of the laser beam 5 can be impinged on by a gas, for example for cleaning and/or cooling the focusing optics 25.

In order to ensure the supply of this gas, a gas compartment 70 is integrated in the replacement module 20, which gas compartment 70 can be flooded with gas, for example cleaned air. As shown in FIG. 5, on a side opposite a fourth wall section 45.4 of the hollow-space wall 45 the lens mount 26 comprises a second wall region 71, which together with the fourth wall section 45.4 of the hollow-space wall 45 delimits the gas compartment 70. As shown in FIGS. 3-6, the gas compartment 70 is separated from the process gas chamber 60 by a partition wall 47 (designed so as to be annular relative to the direction of propagation 5.1 of the laser beam 5), which is sealed against the lens mount 26 by a seal 43.

In order to supply a gas to the gas compartment 70, the stationary part 11 of the machining head 10 is connected to a supply device 95 that provides the required gas at overpressure. In the region of the process gas chamber 70 the sidewall 32 of the replacement module 20 comprises several inlet openings 72 for the respective gas. In each case the inlet openings 72 are arranged in such a manner that they are connected to the supply device 95 when the support structure 30 is moved to the stationary operating position.

By way of a multitude of outlet openings 73 for the respective gas, the gas compartment 70 is connected to an area 75 bordering the focusing optics 25 on the incident end of the laser beam 5, into which area 75, by way of each of the outlet openings 73, in each case a gaseous stream 74 (in FIGS. 4 and 5 designated by an arrow representing one of the outlet openings 73) can be introduced from the gas compartment 70.

As shown in FIG. 5, the respective gaseous stream 74 on the incident end of the laser beam 5 is directed onto the focusing optics 25. Since the respective gaseous stream 74 impinges on the focusing optics 25, the gas can, for example, be used for cleaning and/or cooling the focusing optics 25.

Since the respective gaseous stream 74 impinges on the focusing optics 25 at overpressure, relatively great forces can be transmitted by the gas, which forces act in the direction of the outlet opening 36.1 essentially coaxially to the direction of propagation 5.1 of the laser beam.

The gas compartment 70 is designed in such a manner that these forces resulting from the gas can be compensated for. To this effect the second wall region 71 of the lens mount 26 comprises a piston surface 71.1 (in FIGS. 4 and 5 the outer rims of the piston surface being shown by arrows) that is impinged on by the gas, which piston surface 71.1 is arranged in such a manner that forces that on the incident side of the laser beam 5 are transmitted to the focusing optics 25 by means of the respective gaseous stream 74 are entirely or partly compensated for by forces that are transmitted to the piston surface 71.1 by means of the gas. The extent to which the above-mentioned forces are compensated for essentially depends on the size of the piston surface 71.1 when compared to the area of the focusing optics 25 that is impinged on by the gas. By means of a suitable selection of the size of the piston surface 71.1 a situation can thus be achieved in which all the forces that act on the focusing optics 25 due to forces resulting from the gas can be precisely compensated for.

In this context the term “supply for the gas” can refer to the totality of the following components: the supply device 95, the inlet openings 72, the gas compartment 70 and the outlet openings 73 for the gas.

The term “compensation unit” for compensating for the forces transmitted by the gas can refer to the totality of the following components: the gas compartment 70 and the piston surface 71.1.

The gas compartment 70 is designed so as to be concentric to the direction of propagation 5.1 of the laser beam 5. Furthermore, the piston surface 71.1 that can be impinged on by the gas comprises the shape of a ring that is concentric relative to the direction of propagation 5.1 of the laser beam 5. Since the gas compartment 70 is thus arranged so as to be coaxial to the direction of propagation 5.1 of the laser beam, and also in a ring-shape around the focusing optics 25, as a result of this arrangement the forces transmitted to the piston surface 71.1 can be evenly distributed over the circumference of the focusing optics 25, and thus the disturbance forces resulting from the gas can be eliminated in an efficient manner.

It should be pointed out that the fluidic drive device 40 disclosed in this context can also be replaced by a drive device of some other design (for example by an electromechanical or electromagnetic or manual drive). Furthermore, equipping the replacement module 20 with the process gas chamber 60 and the gas compartment 70 are options which in each case in an advantageous manner can be combined with any drive devices for the focusing optics and in each case provide the basis for the focusing optics 25 to be able to be adjusted with only slight forces, precisely and essentially without the influence of disturbance forces.

Listing of claims:

1. A machining head (10) for a laser machining machine (1) for machining a workpiece (2) by means of a laser beam (5),
comprising focusing optics (25) that focus the laser beam;
comprising a drive device (40) for moving and/or adjusting the focusing optics (25), which drive device is designed as a fluidic drive (40);
comprising at least one supply (90, 62, 60, 63; 95, 72, 70, 73) for at least one pressurized gas, which supply comprises at least one outlet opening (63; 73) for the respective gas, wherein gas can be channelled to the respective outlet opening (63; 73) and from the supply can be introduced, through the respective outlet opening, as a gaseous stream (64; 74) into an area (65, 75) bordering the focusing optics (25);
comprising at least one compensation unit (60, 61.1; 70, 71.1) to compensate for forces that can be transmitted to the focusing optics (25) by the respective gaseous stream;
which compensation unit (60, 61.1; 70, 71.1) comprises a gas chamber (60; 70) that can be flooded with the respective gas, and a piston surface (61.1; 71.1) that can be impinged on by the respective gas and that is rigidly connected to the focusing optics;
wherein the piston surface (61.1; 71.1) is arranged in such a manner that forces that can be transmitted to the focusing optics (25) by means of the respective gaseous stream (64; 74) are entirely or partly compensated for by forces that can be transmitted to the piston surface (61.1; 71.1) by means of the respective gas; and
the gas chamber (60; 70) is integrated in the supply (90, 62, 60, 63; 95, 72, 70, 73) in such a manner that the gas chamber (60; 70) can be flooded with gas that is channelled to the respective outlet opening through at least one inlet opening (62, 72) in the gas chamber (60; 70), wherein after passing through the respective inlet opening the gas must flow through the gas chamber (60; 70) in order to reach the respective outlet opening (63; 73); and the gas chamber (60; 70) is designed so as to be concentric to the direction of propagation (5.1) of the laser beam, and the piston surface (61.1; 71.1) that can be impinged on by the gas comprises the shape of a ring that is concentric relative to the direction of propagation (5.1) of the laser beam (5),
wherein
the respective outlet opening (73) of the supply (95, 72, 70, 73) is arranged in such a manner that the respective gaseous stream can be introduced to an area (75) bordering the focusing optics (25) on the incident end of the laser beam (5), and the respective outlet opening (63; 73) is arranged at a predetermined distance from the focusing optics (25) so that the spatial arrangement of the outlet opening relative to the focusing optics cannot be changed if the focusing optics are moved or displaced.

2. The machining head (10) according to claim 1, wherein the respective outlet opening (63) of the supply (90, 62, 60, 63) is arranged in such a manner that the respective gaseous stream (64) can be introduced to an area (65) bordering the focusing optics (25) on the outlet end of the laser beam (5).

3. The machining head (10) according to claim 2, wherein the gas is a process gas which for influencing a machining process, of the laser machining machine, induced by a laser beam can be introduced to the area (65).

4. (canceled)

5. The machining head according to claim 1, wherein the machining head (10) comprises a stationary part (11) and an interchangeable replacement module (20), which replacement module (20) can be separated as a whole from the stationary part (11); and wherein the replacement module comprises the focusing optics (25) and the respective compensation unit (60, 61.1; 70, 71.1).

6. The machining head according to claim 5,
wherein the drive device (40) comprises at least one driven part (41.1; 42.1); and
the replacement module (20) comprises the respective driven parts (41.1; 42.1) of the drive device (40).

7. A laser machining machine comprising a machining head according to claim 1.
